(19) United States
(12) Patent Application Publication
(10) Pub. No.: US 2026/0265018 A1
(43) Pub. Date: Sep. 10, 2026

(54) ELEVATOR SYSTEM WITH CONTROL SIGNAL ISOLATION DURING SAFE TORQUE OFF

(71) Applicant: Otis Elevator Company, Farmington, CT (US)

(72) Inventors: Steven Michael Millett, Plainville, CT (US); John Noon, Newington, CT (US)

(21) Appl. No.: 19/074,883

(22) Filed: Mar. 10, 2025

(51) Int. Cl. B66B 1/30

(52) U.S. Cl. CPC B66B 1/30

(57) ABSTRACT

An elevator power system for an elevator system, the elevator power system including an inverter configured to provide drive signals to a motor to impart motion to an elevator car; a power controller configured to generate control signals used to control the inverter; an isolation module positioned between the power controller and the inverter, the isolation module configured to prevent the control signals from reaching the inverter in response to a safe torque off mode of the elevator system.

### BACKGROUND

Embodiments described herein relate to elevator systems, and particularly to elevator systems having control signal isolation during safe torque off.

Elevator systems may include a drive configured to power a motor that imparts motion to an elevator car. In certain situations, it is necessary to prevent motion of the elevator car. In an elevator system, “safe torque off” (STO) refers to a safety feature integrated into the drive that prevents the motor from generating torque and causing unintended movement, essentially acting as an emergency stop mechanism to halt the elevator car safely. Integrating STO into existing drive architectures can be challenging, given different voltage levels used in various sections of the drive.

### SUMMARY

According to an embodiment, An elevator power system for an elevator system, the elevator power system including an inverter configured to provide drive signals to a motor to impart motion to an elevator car; a power controller configured to generate control signals used to control the inverter; an isolation module positioned between the power controller and the inverter, the isolation module configured to prevent the control signals from reaching the inverter in response to a safe torque off mode of the elevator system.

In addition to one or more of the features described herein, or as an alternative, further embodiments may include wherein the isolation module includes a first isolator including an input section and an output section.

In addition to one or more of the features described herein, or as an alternative, further embodiments may include a safety module, the safety module including: a power source; a switch or switches connecting the power source to the first isolator; monitoring of the switch or switches to validate correct operation; wherein the switch or switches are closed or opened in response to a safety signal indicating the status of the elevator system.

In addition to one or more of the features described herein, or as an alternative, further embodiments may include wherein the switch or switches are closed when the safety signal has an enable operation state and the switch or switches are open when the safety signal has a disable operation state.

In addition to one or more of the features described herein, or as an alternative, further embodiments may include wherein the output section of the first isolator is coupled to the power source of the safety module through the switch.

In addition to one or more of the features described herein, or as an alternative, further embodiments may include wherein the input section of the first isolator is coupled to the power source of the safety module through the switch.

In addition to one or more of the features described herein, or as an alternative, further embodiments may include wherein the input section of the first isolator is coupled to independent power and the output section of the first isolator is coupled to the power source of the safety module through the switch.

In addition to one or more of the features described herein, or as an alternative, further embodiments may include wherein the output section of the first isolator is coupled to independent power and the input section of the first isolator is coupled to the power source of the safety module through the switch.

In addition to one or more of the features described herein, or as an alternative, further embodiments may include wherein the isolation module includes a second isolator including an input section and an output section.

In addition to one or more of the features described herein, or as an alternative, further embodiments may include wherein the input section of the second isolator is coupled to a second power source of the safety module through a second switch.

In addition to one or more of the features described herein, or as an alternative, further embodiments may include wherein the output section of the second isolator is coupled to a second power source of the safety module through a second switch.

In addition to one or more of the features described herein, or as an alternative, further embodiments may include wherein the output section of the second isolator is coupled to independent power and the input section of the second isolator is coupled to a second power source of the safety module through a second switch.

In addition to one or more of the features described herein, or as an alternative, further embodiments may include wherein the input section of the second isolator is coupled to independent power and the output section of the second isolator is coupled to a second power source of the safety module through a second switch.

In addition to one or more of the features described herein, or as an alternative, further embodiments may include wherein the second isolator is in electrical series with the first isolator.

In addition to one or more of the features described herein, or as an alternative, further embodiments may include wherein the isolation module comprises a digital isolation module.

According to another embodiment, an elevator system includes a hoistway; an elevator car configured to travel in the hoistway and an elevator power system as recited herein.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited by the accompanying figures in which like reference numerals indicate similar elements.

FIG. 1 an elevator system that may employ various embodiments of the present disclosure in an example embodiment.

FIG. 2 depicts an elevator power system in an example embodiment.

FIG. 3 depicts an isolator in an example embodiment.

### DETAILED DESCRIPTION

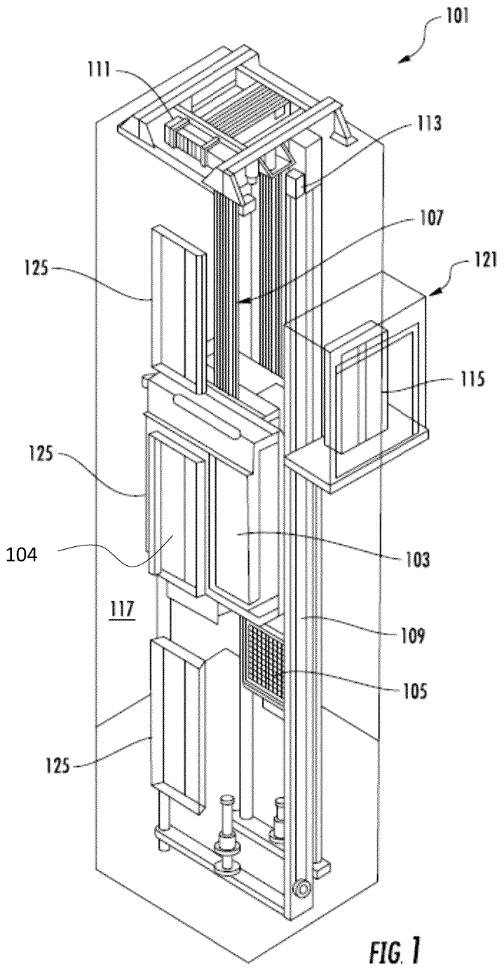

FIG. 1 is a perspective view of an elevator system 101 including an elevator car 103, a counterweight 105, a tension member 107, a guide rail 109, a machine 111, a position reference system 113, and a controller 115. The elevator car 103 and the counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft or the hoistway 117 and along the guide rail 109.

The tension member 107 engages the machine 111, which is part of an overhead structure of the elevator system 101. The machine 111 is configured to control movement of the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of the elevator car 103 and/or the counterweight 105, as known in the art. For example, without limitation, the position reference system 113 can be an encoder, sensor, or other system and can include velocity sensing, absolute position sensing, etc., as will be appreciated by those of skill in the art.

The controller 115 may be located, as shown, in a controller room 121 of the elevator shaft 117 and is configured to control the operation of the elevator system 101, and particularly the elevator car 103. It is to be appreciated that the controller 115 need not be in the controller room 121 but may be in the hoistway or other location in the elevator system. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along the guide rail 109, the elevator car 103 may stop at one or more landings 125 as controlled by the controller 115. Although shown in the controller room 121, those of skill in the art will appreciate that the controller 115 can be located and/or configured in other locations or positions within the elevator system 101. In one embodiment, the controller 115 may be located remotely or in a distributed computing network (e.g., cloud computing architecture). The controller 115 may be implemented using a processor-based machine, such as a personal computer, server, distributed computing network, etc.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

The elevator system 101 also includes one or more elevator doors 104. The elevator door 104 may be attached to the elevator car 103 or the elevator door 104 may be located on a landing 125 of the elevator system 101, or both. Embodiments disclosed herein may be applicable to both an elevator door 104 attached to the elevator car 103 or an elevator door 104 located on a landing 125 of the elevator system 101, or both. The elevator door 104 opens to allow passengers to enter and exit the elevator car 103.

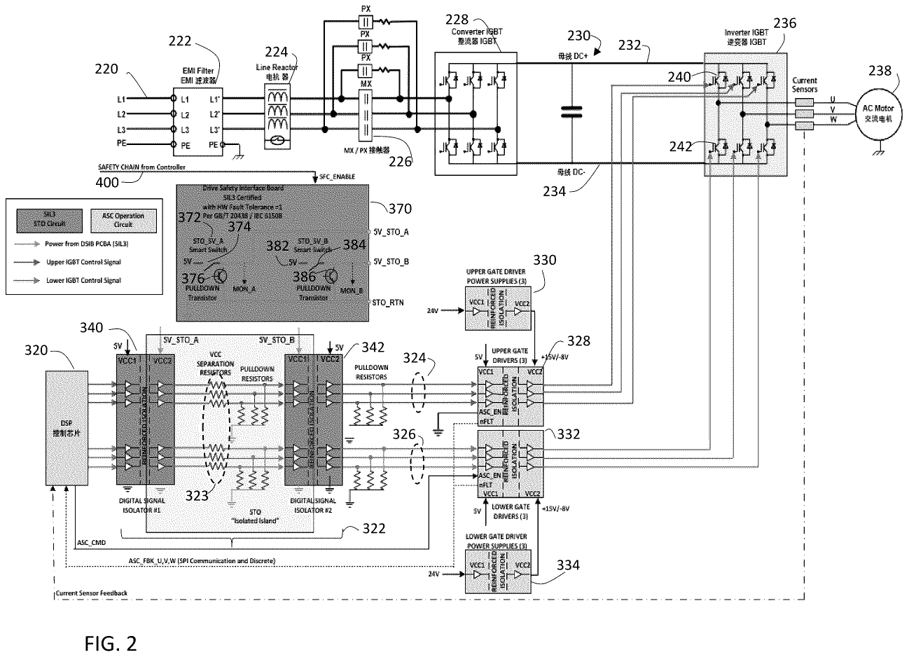

FIG. 2 depicts an elevator power system in an example embodiment. The elevator power system, also referred to as a drive, receives alternating current (AC) power from an AC source 220. The AC source 220 may be multi-phase AC power (e.g., three-phase AC power, L1, L2, L3, and a protective earth (PE) conductor), referred to as mains power or grid power. The AC source 220 is supplied to a multiphase EMI filter 222 and a multiphase line reactor 224, to remove spurious components from the AC source 220. The output of the line reactor 224 is supplied to a converter 228 through a main relay 226.

The converter 228 is an AC-DC converter operating under control of a power controller 320. The power controller 320 may be implemented by the elevator controller 115 or may be a separate controller. Power controller 320 may be implemented using a general-purpose microprocessor executing a computer program stored on a storage medium to perform the operations described herein. Alternatively, the power controller 320 may be implemented in hardware (e.g., ASIC, FPGA) or in a combination of hardware/software.

The output of the converter 228 is a DC voltage applied across a DC bus 230 having a first DC link 232 (positive) and a second DC link 234 (negative). An inverter 236 converts the DC voltage into motor drive signals (e.g., variable frequency/variable voltage AC drive signals) which are supplied to an AC motor 238 to impart motion to the elevator car 103. The motor drive signals are three phase drive signals, shown as U, V, W, in FIG. 2. The inverter 236 includes three phase legs, each leg including a first switch 240 and a second switch 242 connected in series between the first DC link 232 and the second DC link 234. The first switch 240 is connected to the first DC link 232 and the second switch 242 is connected to the second DC link 234. The drive signals are produced at the junction of the first switch 240 and the second switch 242 in response to command signals from the power controller 320. In example embodiments, the power controller 320 generates pulse width modulation (PWM) control signals to control the first switches 240 and the second switches 242 to generate drive signals on each phase U, V, W.

In operation, the power controller 320 transmits control signals through a digital isolation module 322 (described in further detail herein). The control signals may be arranged in a first group 324 for the first switches 240 and a second group 326 for the second switches 242. From the isolation module 322, the first group of control signals 324 are provided to a first gate driver 328. The first gate driver 328 is powered by a first gate driver power supply 330. From the isolation module 322, the second group of control signals 326 are provided to a second gate driver 332. The second gate driver 332 is powered by a second gate driver power supply 334. As known in the art, the first gate driver 328 and the second gate driver 332 act as a power amplifier, receiving low-power control signals from the power controller 320 and generating higher power control signals used to turn on and off the first switches 240 and the second switches 242.

The isolation module 322 operates to prevent the control signals from the power controller 320 from reaching the inverter 236 during a safe torque off (STO) mode. As noted above, STO refers to a safety feature integrated into the elevator power system that prevents the motor 238 from generating torque and causing unintended movement of the elevator car 103. The isolation module 322 includes a first isolator 340 and a second isolator 342, connected in series, that transmit the control signals from the power controller 320 to the first gate driver 328 and the second gate driver 332. The signal paths between the first isolator 340 and the second isolator 342 include separation resistors 323 in series between the first isolator 340 and the second isolator 342. The separation resistors 323 prevent the first isolator 340 from powering the second isolator 342 in the event of a failure in the first isolator 340, and vice versa.

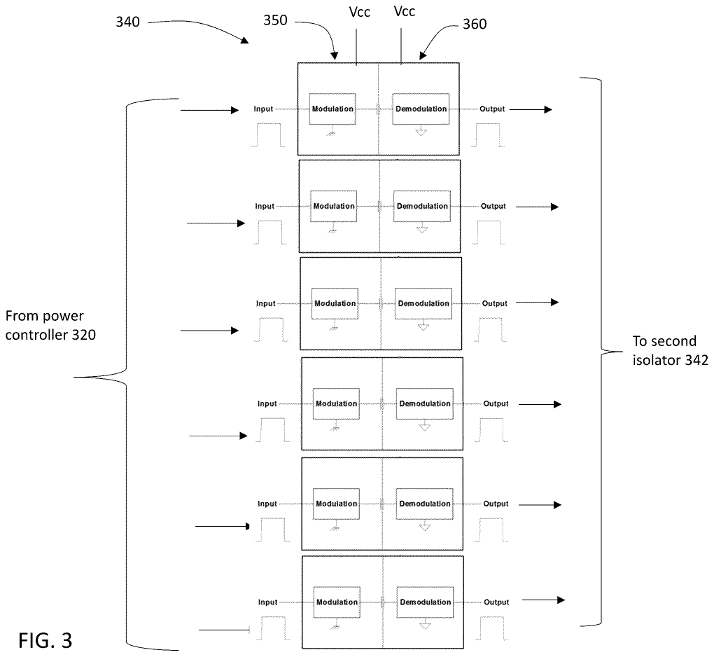

FIG. 3 depicts a first digital isolator 340 in an example embodiment. The first isolator 340 includes an input section 350 and an output section 360. The first isolator 340 is a capacitive galvanic isolator, but it is understood that other types of isolators may be used, such as optical isolators or magnetic isolators. The input section 350 includes a modulator, and the output section 360 includes a demodulator. The first isolator 340 uses capacitive isolation (e.g., SiO2 capacitors) to achieve double isolation between the input side and the output side and passes high frequency AC signals through these insulated.

The modulator and the demodulator require power, shown as Vcc, to operate. If power is removed from either the input section 350 or the output section 360, control signals from the power controller 320 will not pass through the first isolator 340. As shown in FIG. 3, the input section 350 includes six paths from the input section 350 to the output section 360. Each path corresponds to an individual control signal from the power controller 320. The second isolator 342 is constructed in a similar manner.

Referring to FIG. 2, the isolation module 322 can either transmit or block the control signals from the power controller 320 in response to a safety condition in the elevator system 101. A safety module 370 powers one or more of the input sections and the output sections of the first isolator 340 and the second isolator 342. The safety module 370 may implemented by a circuit board having the appropriate logic devices to perform the operations described herein. The safety module 370 is designed and certified as a safety circuit.

The safety module 370 includes a first power source 372, which may be 5-volt DC. The first power source 372 is connected to the first isolator 340 through a first switch 374. The first switch 374 may be a mechanical switch (e.g., a relay) or an electrical switch (e.g., a transistor). The first switch 374 is controlled by a safety signal 400 provided to the safety module 370. The safety signal 400 may be generated by a safety chain employed in the elevator system 101.

A first pulldown component 376 connects the first power source 372 to ground. The first pulldown component 376 may be a transistor which is rendered conductive or non-conductive in response to the safety signal 400. In operation, when the safety signal 400 has a first state (e.g., enable operation or logic 1), the first switch 374 is closed and the first pulldown component 376 is non-conductive, allowing the first power source 372 to power one or more of the input section and the output section of the first isolator 340, as described in further detail herein. When the safety signal 400 has a second state (e.g., disable operation or logic 0), the first switch 374 is open and the first pulldown component 376 is conductive, preventing the first power source 372 from powering the first isolator 340.

The safety module 370 includes a second power source 382, which may be 5-volt DC. The second power source 382 is connected to the second isolator 342 through a second switch 384. The second switch 384 may be a mechanical switch (e.g., a relay) or an electrical switch (e.g., a transistor). The second switch 384 is controlled by the safety signal 400 provided to the safety module 370.

A second pulldown component 386 connects the second power source 382 to ground. The second pulldown component 386 may be a transistor which is rendered conductive or non-conductive in response to the safety signal 400. In operation, when the safety signal 400 has a first state (e.g., enable operation or logic 1), the second switch 384 is closed and the second pulldown component 386 is non-conductive, allowing the second power source 382 to power the second isolator 342, as described in further detail herein. When the safety signal 400 has a second state (e.g., disable operation or logic 0), the second switch 384 is open and the second pulldown component 386 is conductive, preventing the second power source 384 from powering the second isolator 342.

In the example shown in FIG. 2, the input section 350 of the first isolator 340 is supplied independent power Vcc1 and the output section 360 of the second isolator 342 is supplied independent power Vcc2 (which may be the same source as Vcc1). The input section 350 of the first isolator 340 and the output section 360 of the second isolator 342 are powered independent of the state of the safety signal 400. The output section 360 of the first isolator 340 and the input section 350 of the second isolator 342 are powered by the first power source 372 of the safety module 370 and the second power source 382 of the safety module 370, respectively. In operation, when the safety signal 400 is in the first state (e.g., enable operation), the first switch 374 is closed and the first pulldown component 376 is non-conductive, thereby supplying power from the first power source 372 to the output section 360 of the first isolator 340. At the same time, when the safety signal 400 is in the first state (e.g., enable operation), the second switch 384 is closed and the second pulldown component 386 is non-conductive, thereby supplying power from the second power source 382 to the output section 360 of the first isolator 340. This results in the isolation module 322 transmitting the control signals from the power controller 320 to the first gate driver 328 and the second gate driver 332, and ultimately to the inverter 236.

When the safety signal 400 is in the second state (e.g., disable operation), the first switch 374 is open and the first pulldown component 376 is conductive, interrupting power from the first power source 372 to the output section 360 of the first isolator 340. At the same time, when the safety signal 400 is in the second state (e.g., disable operation), the second switch 384 is open and the second pulldown component 386 is conductive, interrupting power from the second power source 382 to the input section 350 of the second isolator 342.

As the output section 360 of the first isolator 340 and the input section 350 of the second isolator 342 require power to operate, this results in the isolation module 322 preventing any control signals from the power controller 320 from reaching the first gate driver 328 and the second gate driver 332. The first gate driver 328 may default to turning off the first switches 240 in the inverter 236. The second gate driver 332 may default to turning on the second switches 242 in the inverter 236. This shorts the windings of the motor 238 to provide dynamic braking of the motor. In other embodiments, the second switches 242 in the inverter 236 may be turned on by a secondary signal, referred to as an active short circuit command, shown as ASC_CMD in FIG. 2.

The power connections to the first isolator 340 and the second isolator 342 may be the opposite of that shown in FIG. 2. In this variation, the output section 360 of the first isolator 340 is connected to independent power Vcc1 and the input section 350 of the second isolator 342 is connected to independent power Vcc2 (which may be the same source as Vcc1). The output section 360 of the first isolator 340 and the input section 350 of the second isolator 342 are powered independent of the state of the safety signal 400. The input section 350 of the first isolator 340 is connected to the first power source 372 (through the first switch 374) and the output section 360 of the second isolator 342 is connected to the second power source 382 (through the second switch 374).

In some embodiments, the isolation module 322 includes a single isolator rather than a first isolator 340 and a second isolator 342 in series. In a single isolator embodiment, the input section of the isolator is connected to the first power source 372 (through the first switch 374) and the output section of the isolator is connected to the second power source 372 (through the second switch 374).

Embodiments of the power system described herein provide several benefits. Using the isolation module 322 and the safety module 370, control signals from the power controller 320 are prevented from reaching the inverter 236 when the elevator system is disabled. The isolation module 322 provides a near certain confidence that control signals from the power controller 320 are prevented from reaching the inverter 236.

In some embodiments, use of the isolation module 322 and the safety module 370 separates the low voltage components (e.g., the isolation module 322 and the safety module 370) from the high voltage components (the power controller 320, the gate drivers 328/332 and the gate driver power supplies 330/334). This allows the isolation module 322 and the safety module 370 to be incorporated in various power systems architectures, regardless of the voltage requirements of a particular power system.

The terminology used herein is for the purpose of describing particular embodiments only, and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification and/or the claims, specify the presence of stated features, steps, operations, elements, and/or components, but do not preclude the presence or addition of one or more other features, steps, operations, elements, components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description but is only limited by the scope of the appended claims.

What is claimed is:

1. An elevator power system for an elevator system, the elevator power system comprising:
an inverter configured to provide drive signals to a motor to impart motion to an elevator car;
a power controller configured to generate control signals used to control the inverter;
an isolation module positioned between the power controller and the inverter, the isolation module configured to prevent the control signals from reaching the inverter in response to a safe torque off mode of the elevator system.

2. The elevator power system of claim 1, wherein the isolation module includes a first isolator including an input section and an output section.

3. The elevator power system of claim 2, further comprising a safety module, the safety module including:
a power source;
a switch or switches connecting the power source to the first isolator;
monitoring of the switch or switches to validate correct operation;
wherein the switch or switches are closed or opened in response to a safety signal indicating the status of the elevator system.

4. The elevator power system of claim 3, wherein the switch or switches are closed when the safety signal has an enable operation state and the switch or switches are open when the safety signal has a disable operation state.

5. The elevator power system of claim 3, wherein the output section of the first isolator is coupled to the power source of the safety module through the switch.

6. The elevator power system of claim 3, wherein the input section of the first isolator is coupled to the power source of the safety module through the switch.

7. The elevator power system of claim 3, wherein the input section of the first isolator is coupled to independent power and the output section of the first isolator is coupled to the power source of the safety module through the switch.

8. The elevator power system of claim 3, wherein the output section of the first isolator is coupled to independent power and the input section of the first isolator is coupled to the power source of the safety module through the switch.

9. The elevator power system of claim 3, wherein the isolation module includes a second isolator including an input section and an output section.

10. The elevator power system of claim 9, wherein the input section of the second isolator is coupled to a second power source of the safety module through a second switch.

11. The elevator power system of claim 9, wherein the output section of the second isolator is coupled to a second power source of the safety module through a second switch.

12. The elevator power system of claim 9, wherein the output section of the second isolator is coupled to independent power and the input section of the second isolator is coupled to a second power source of the safety module through a second switch.

13. The elevator power system of claim 9, wherein the input section of the second isolator is coupled to independent power and the output section of the second isolator is coupled to a second power source of the safety module through a second switch.

14. The elevator power system of claim 9, wherein the second isolator is in electrical series with the first isolator.

15. The elevator power system of claim 2, wherein the isolation module comprises a digital isolation module.

16. An elevator system comprising:
a hoistway;
an elevator car configured to travel in the hoistway;
the elevator power system according to claim 1.
